(19) United States
(12) Patent Application Publication
(10) Pub. No.: US 2020/0372250 A1
(43) Pub. Date: Nov. 26, 2020

(54) Service Processing Method and Related Apparatus

(71) Applicant: Huawei Technologies Co., Ltd., Shenzhen (CN)

(72) Inventors: Han Jiang, Hangzhou (CN); Chao Ren, Hangzhou (CN); Liangfang Qian, Hangzhou (CN)

(21) Appl. No.: 16/992,427

(22) Filed: Aug. 13, 2020

Related U.S. Application Data
(63) Continuation of application No. PCT/CN2019/086127, filed on May 9, 2019.

(30) Foreign Application Priority Data
Nov. 21, 2018 (CN) 201811392818.7

(51) Int. Cl. G06K 9/00; G06K 9/66; G06F 3/16

(52) U.S. Cl. CPC G06K 9/00624; G06F 3/04817; G06F 3/165; G06K 9/66

(57) ABSTRACT

A service processing method includes obtaining image data is using a sensor configured on the terminal device, wherein a current scene is automatically matched based on the image data, and wherein a processing manner corresponding to the current scene is automatically run. A two-dimensional code (or including text related to “payment”) is collected, and it is identified that a current scene is a payment scene, and then payment software is automatically started.

### CROSS-REFERENCE TO RELATED APPLICATIONS

This application is a continuation of International Patent Application No. PCT/CN2019/086127, filed on May 9, 2019, which claims priority to Chinese Patent 201811392818.7, filed on Nov. 21, 2018. The disclosures of the aforementioned applications are hereby incorporated by reference in their entireties.

### TECHNICAL FIELD

This application relates to the field of artificial intelligence (AI), and in particular, to a service processing method and a related apparatus.

### BACKGROUND

With development of science and technology, a terminal device represented by a smartphone plays an increasingly important role in people's life. The smartphone is used as an example. In daily life, the smartphone may be used to scan a picture that carries a two-dimensional code, to implement a function of a related application program or obtain information.

Currently, when the smartphone is in a screen-off state, if an action of scanning a two-dimensional code needs to be performed, a screen needs to be turned on first, and after the smartphone is unlocked, a related application program needs to be operated to complete scanning of the two-dimensional code.

However, the foregoing action of scanning, by the smartphone, the picture that carries the two-dimensional code has disadvantages, for example, operations are complex, and intelligence is low. Consequently, use convenience of a user is reduced.

### SUMMARY

Embodiments of this application provide a service processing method and a related apparatus that are applied to a terminal device. The terminal device may obtain to-be-processed data using a sensor in the terminal device. A scene identification model in the terminal device determines a current scene based on the to-be-processed data, and determines a corresponding service processing manner based on the current scene. Because the service processing manner is a service processing manner that is preset in the terminal device, operation steps of a user can be simplified, operation intelligence can be improved, and use convenience of the user can be improved.

To resolve the foregoing technical problem, the embodiments of this application provide the following technical solutions.

According to a first aspect, an embodiment of this application provides a service processing method, applied to a terminal device and including obtaining to-be-processed data, where the to-be-processed data is generated using data collected by a sensor, the sensor includes at least an infrared image sensor, and the to-be-processed data includes at least to-be-processed image data generated using image data collected by the infrared image sensor, determining, using a scene identification model, a target scene corresponding to the to-be-processed data, where the scene identification model is obtained through training using a sensor data set and a scene type set, and determining a service processing manner based on the target scene.

In this application, the terminal device collects data using a sensor that is deployed in the terminal device or is connected to the terminal device, where the sensor includes at least the infrared image sensor, and the terminal device generates the to-be-processed data based on the collected data, where the to-be-processed data includes at least the to-be-processed image data generated using the image data collected by the infrared image sensor. After obtaining the to-be-processed data, the terminal device may determine, using the scene identification model, the target scene corresponding to the to-be-processed data, where the scene identification model is obtained through offline training using a data set obtained by the sensor through collection and a scene type set corresponding to different data, and offline training means performing model design and training using a deep learning framework. After determining the current target scene, the terminal device may determine a corresponding service processing manner based on the target scene. The target scene in which the terminal device is currently located may be determined using the data collected by the sensor and the scene identification model, and the corresponding service processing manner is determined based on the target scene such that the terminal device can automatically determine the service processing manner corresponding to the target scene, without performing an additional operation, thereby improving use convenience of a user. The infrared image sensor is always on. With development of technologies, the image sensor in this application may not be an infrared sensor, provided that the sensor can collect an image. The infrared sensor is used only because power consumption of the infrared sensor is relatively low in current known sensors.

In a possible implementation of the first aspect, the determining, using a scene identification model, a target scene corresponding to to-be-processed data includes determining, using an AI algorithm in the scene identification model, the target scene corresponding to the to-be-processed data, where the AI algorithm includes a deep learning algorithm, and the AI algorithm is run on an AI processor.

In this application, the terminal device specifically determines, using the AI algorithm in the scene identification model, the target scene corresponding to to-be-processed data. The AI algorithm includes the deep learning algorithm, and is run on the AI processor in the terminal device. Because the AI processor has a strong parallel computing capability, and is characterized by high efficiency when the AI algorithm is run, the scene identification model determines a specific target scene using the AI algorithm, where the AI algorithm is run on the AI processor in the terminal device, thereby improving efficiency of scene identification, and further improving use convenience of the user.

In a possible implementation of the first aspect, the sensor further includes at least one of an audio collector and a first sub-sensor, the to-be-processed data includes at least one of to-be-processed audio data and first to-be-processed sub-data, the to-be-processed audio data is generated using audio data collected by the audio collector, and the first to-be-processed sub-data is generated using first sub-sensor data collected by the first sub-sensor.

In this application, in addition to the infrared image sensor, the sensor deployed in the terminal device further includes one of the audio collector and the first sub-sensor. The first sub-sensor may be one or more of the following sensors an acceleration sensor, a gyroscope, an ambient light sensor, a proximity sensor, and a geomagnetic sensor. The audio collector collects the audio data, and the audio data is processed by the terminal device to generate the to-be-processed audio data. The first sub-sensor collects the first sub-sensor data, and the first sub-sensor data is processed by the terminal device to generate to-be-processed first sub-sensor data. The terminal device collects data in a plurality of dimensions using a plurality of sensors, thereby improving accuracy of scene identification.

In a possible implementation of the first aspect, the obtaining to-be-processed data includes when a preset running time of image collection arrives, obtaining the image data using the infrared image sensor, where the image data is data collected by the infrared image sensor, and obtaining the to-be-processed image data using an image signal processor (ISP), where the to-be-processed image data is generated by the ISP based on the image data, and/or when a preset running time of audio collection arrives, obtaining the audio data using the audio collector, and obtaining the to-be-processed audio data using an audio signal processor (ASP), where the to-be-processed audio data is generated by the ASP based on the audio data, and/or when a first preset running time arrives, obtaining the first sub-sensor data using the first sub-sensor, where the first sub-sensor data is data collected by the first sub-sensor, and obtaining the first to-be-processed sub-data using a first sub-sensor processor, where the first to-be-processed sub-data is generated by the first sub-sensor processor based on the first sub-sensor data.

In this application, one or more of the infrared image sensor, the audio collector, and the first sub-sensor may separately collect data, corresponding to the sensor, after their respective preset running times arrive. After original sensor data is collected, the terminal device processes the original sensor data using a processor corresponding to the sensor, to generate to-be-processed sensor data. The preset running time is set, and the sensor is started to collect data through timing such that the collected original data can be processed by the processor corresponding to the sensor, thereby reducing buffer space occupied by the scene identification model, reducing power consumption of the scene identification model, and improving use duration of the terminal device in a standby mode.

In a possible implementation of the first aspect, the determining a service processing manner based on the target scene includes if the target scene is a two-dimensional code scanning scene, determining, based on the two-dimensional code scanning scene, that the service processing manner is to start a primary image sensor in the terminal device and/or start an application program that is in the terminal device and that supports a two-dimensional code scanning function.

In this application, when determining, based on the data collected by the one or more sensors in the terminal device, that the target scene corresponding to the data collected by the sensors is the two-dimensional code scanning scene, the terminal device determines a service processing manner corresponding to the two-dimensional code scanning scene. The service processing manner includes starting the primary image sensor in the terminal device. The terminal device may scan a two-dimensional code using the primary image sensor. Alternatively, the terminal device may start the application program that supports the two-dimensional code scanning function, for example, start an application program WECHAT and enable a two-dimensional code scanning function in WECHAT. The primary image sensor and the application program that supports the two-dimensional code scanning function may be both started, or the primary image sensor or the application program that supports the two-dimensional code scanning function may be started based on a preset instruction or an instruction received from the user. This is not limited herein. In addition to scanning the two-dimensional code, the primary image sensor may be further used to scan another icon such as a bar code. This is not limited herein. After determining, using the scene identification model and the data collected by the multidimensional sensor, that the target scene is the two-dimensional code scanning scene, the terminal device may automatically execute a related service processing manner, thereby improving intelligence of the terminal device and operation convenience of the user.

In a possible implementation of the first aspect, the determining a service processing manner based on the target scene includes if the target scene is a conference scene, determining, based on the conference scene, that the service processing manner is to enable a silent mode of the terminal device, and/or enable a silent function of an application program in the terminal device, and/or display a silent mode icon in an always on display area on a standby screen of the terminal device, where the silent mode icon is used to enable the silent mode.

In this application, when determining, based on the data collected by the one or more sensors in the terminal device, that the target scene corresponding to the data collected by the sensors is the conference scene, the terminal device determines a service processing manner corresponding to the conference scene. The service processing manner includes enabling the silent mode of the terminal device. When the terminal device is in the silent mode, all application programs running on the terminal device are in a silent state. Alternatively, the terminal device may enable the silent function of the application program running on the terminal device, for example, enable a silent function of an application program WECHAT. In this case, alert sound of WECHAT is switched to the silent mode. Alternatively, the terminal device may display the silent mode icon in the always on display area on the standby screen of the terminal device. The terminal device may receive a silent operation instruction of the user using the silent mode icon, and the terminal device enables the silent mode in response to the silent operation instruction. After determining, using the scene identification model and the data collected by the multidimensional sensor, that the target scene is the conference scene, the terminal device may automatically execute a related service processing manner, thereby improving intelligence of the terminal device and operation convenience of the user.

In a possible implementation of the first aspect, the determining a service processing manner based on the target scene includes if the target scene is a motion scene, determining, based on the motion scene, that the service processing manner is to enable a motion mode of the terminal device, and/or enable a motion mode function of an application program in the terminal device, and/or display a music play icon in an always on display area on a standby screen of the terminal device, where the motion mode of the terminal device includes a step counting function, and the music play icon is used to start or pause music play.

In this application, when determining, based on the data collected by the one or more sensors in the terminal device, that the target scene corresponding to the data collected by the sensors is the motion scene, the terminal device determines a service processing manner corresponding to the motion scene. The service processing manner includes enabling the motion mode of the terminal device. When the terminal device is in the motion mode, the terminal device starts a step counting application program and a physiological data monitoring application program, and records a quantity of steps and related physiological data of the user using a related sensor in the terminal device. Alternatively, the terminal device may enable the motion mode function of the application program in the terminal device, for example, enable a motion function of an application program NETEASE Cloud Music. In this case, a play mode of NETEASE Cloud Music is the motion mode. Alternatively, the terminal device may display the music play icon in the always on display area on the standby screen of the terminal device. The terminal device may receive a music play instruction of the user using the music play icon, and the terminal device starts or pauses music play in response to the music play instruction. After determining, using the scene identification model and the data collected by the multidimensional sensor, that the target scene is the motion scene, the terminal device may automatically execute a related service processing manner, thereby improving intelligence of the terminal device and operation convenience of the user.

In a possible implementation of the first aspect, the determining a service processing manner based on the target scene includes if the target scene is a driving scene, determining, based on the driving scene, that the service processing manner is to enable a driving mode of the terminal device, and/or enable a driving mode function of an application program in the terminal device, and/or display a driving mode icon in an always on display area on a standby screen of the terminal device, where the driving mode of the terminal device includes a navigation function and a voice assistant, and the driving mode icon is used to enable the driving mode.

In this application, when determining, based on the data collected by the one or more sensors in the terminal device, that the target scene corresponding to the data collected by the sensors is the driving scene, the terminal device determines a service processing manner corresponding to the driving scene. The service processing manner includes enabling the driving mode of the terminal device. When the terminal device is in the driving mode, the terminal device starts the voice assistant, where the terminal device may perform a related operation based on a voice instruction entered by the user, and the terminal device may further enable the navigation function. Alternatively, the terminal device may enable the driving mode function of the application program in the terminal device, for example, enable a driving mode function of an application program AMAP. In this case, a navigation mode of NETEASE Cloud Music is the driving mode. Alternatively, the terminal device may display the driving mode icon in the always on display area on the standby screen of the terminal device. The terminal device may receive a driving mode instruction of the user using the driving mode icon, and the terminal device enables the driving mode in response to the driving mode instruction. After determining, using the scene identification model and the data collected by the multidimensional sensor, that the target scene is the driving scene, the terminal device may automatically execute a related service processing manner, thereby improving intelligence of the terminal device and operation convenience of the user.

According to a second aspect, an embodiment of this application provides a terminal device, including a sensor and a processor. The sensor includes at least an infrared image sensor. The processor is configured to obtain to-be-processed data, where the to-be-processed data is generated using data collected by the sensor, and the to-be-processed data includes at least to-be-processed image data generated using image data collected by the infrared image sensor. The processor is further configured to determine, using a scene identification model, a target scene corresponding to the to-be-processed data, where the scene identification model is obtained through training using a sensor data set obtained by the sensor and a scene type set. The processor is further configured to determine a service processing manner based on the target scene. The processor is further configured to perform the service processing method according to the first aspect.

According to a third aspect, an embodiment of this application provides a service processing apparatus, where the service processing apparatus is applied to a terminal device and includes an obtaining unit configured to obtain to-be-processed data, where the to-be-processed data is generated using data collected by a sensor, the sensor includes at least an infrared image sensor, and the to-be-processed data includes at least to-be-processed image data generated using image data collected by the infrared image sensor, and a determining unit configured to determine, using a scene identification model, a target scene corresponding to the to-be-processed data, where the scene identification model is obtained through training using a sensor data set and a scene type set, where the determining unit is further configured to determine a service processing manner based on the target scene.

In a possible implementation of the third aspect, the determining unit is specifically configured to determine, using an AI algorithm in the scene identification model, the target scene corresponding to the to-be-processed data, where the AI algorithm includes a deep learning algorithm, and the AI algorithm is run on an AI processor.

In a possible implementation of the third aspect, the sensor further includes at least one of an audio collector and a first sub-sensor, the to-be-processed data includes at least one of to-be-processed audio data and first to-be-processed sub-data, the to-be-processed audio data is generated using audio data collected by the audio collector, and the first to-be-processed sub-data is generated using first sub-sensor data collected by the first sub-sensor.

In a possible implementation of the third aspect, the obtaining unit is specifically configured to when a preset running time of image collection arrives, obtain, by the obtaining unit, the image data using the infrared image sensor, where the image data is data collected by the infrared image sensor, and the obtaining unit is specifically configured to obtain the to-be-processed image data using an ISP, where the to-be-processed image data is generated by the ISP based on the image data, and/or the obtaining unit is specifically configured to when a preset running time of audio collection arrives, obtain, by the obtaining unit, the audio data using the audio collector, and the obtaining unit is specifically configured to obtain the to-be-processed audio data using an ASP, where the to-be-processed audio data is generated by the ASP based on the audio data, and/or the obtaining unit is specifically configured to when a first preset running time arrives, obtain, by the obtaining unit, the first sub-sensor data using the first sub-sensor, where the first sub-sensor data is data collected by the first sub-sensor, and the obtaining unit is specifically configured to obtain the first to-be-processed sub-data using a first sub-sensor processor, where the first to-be-processed sub-data is generated by the first sub-sensor processor based on the first sub-sensor data.

In a possible implementation of the third aspect, the determining unit is specifically configured to if the determining unit determines that the target scene is a two-dimensional code scanning scene, determine, by the determining unit based on the two-dimensional code scanning scene, that the service processing manner is to start a primary image sensor in the terminal device and/or start an application program that is in the terminal device and that supports a two-dimensional code scanning function.

In a possible implementation of the third aspect, the determining unit is specifically configured to if the determining unit determines that the target scene is a conference scene, determine, by the determining unit based on the conference scene, that the service processing manner is to enable a silent mode of the terminal device, and/or enable a silent function of an application program in the terminal device, and/or display a silent mode icon in an always on display area on a standby screen of the terminal device, where the silent mode icon is used to enable the silent mode.

In a possible implementation of the third aspect, the determining unit is specifically configured to if the determining unit determines that the target scene is a motion scene, determine, by the determining unit based on the motion scene, that the service processing manner is to enable a motion mode of the terminal device, and/or enable a motion mode function of an application program in the terminal device, and/or display a music play icon in an always on display area on a standby screen of the terminal device, where the motion mode of the terminal device includes a step counting function, and the music play icon is used to start or pause music play.

In a possible implementation of the third aspect, the determining unit is specifically configured to if the determining unit determines that the target scene is a driving scene, determine, by the determining unit based on the driving scene, that the service processing manner is to enable a driving mode of the terminal device, and/or enable a driving mode function of an application program in the terminal device, and/or display a driving mode icon in an always on display area on a standby screen of the terminal device, where the driving mode of the terminal device includes a navigation function and a voice assistant, and the driving mode icon is used to enable the driving mode.

According to a fifth aspect, an embodiment of this application provides a computer program product that includes an instruction, where when the computer program product is run on a computer, the computer is enabled to perform the storage block processing method according to the first aspect.

According to a sixth aspect, an embodiment of this application provides a computer readable storage medium, where the computer readable storage medium stores a packet processing instruction, and when the instruction is run on a computer, the computer is enabled to perform the storage block processing method according to the first aspect.

According to a seventh aspect, this application provides a chip system, where the chip system includes a processor configured to support a network device in implementing a function in the foregoing aspect, for example, sending or processing data and/or information in the foregoing method. In a possible design, the chip system further includes a memory. The memory is configured to store a program instruction and data that are necessary for the network device. The chip system may include a chip, or may include a chip and another discrete device.

According to an eighth aspect, this application provides a service processing method, where the method is applied to a terminal device, an always on image sensor is configured on the terminal device, and the method includes obtaining data, where the data includes image data collected by the image sensor, determining, using a scene identification model, a target scene corresponding to the data, where the scene identification model is obtained through training using a sensor data set and a scene type set, and determining a service processing manner based on the target scene.

For other implementations of the eighth aspect, refer to the foregoing implementations of the first aspect. Details are not described herein again.

According to a ninth aspect, this application provides a terminal device, where an always on image sensor is configured on the terminal device, and the terminal device is configured to implement the method in any one of the foregoing implementations.

In addition, for technical effects brought by any implementation of the second to the ninth aspects, refer to technical effects brought by the implementations of the first aspect. Details are not described herein.

It can be learned from the foregoing technical solutions that, the embodiments of this application have the following advantages.

In the foregoing method, the terminal device may obtain the to-be-processed data using the sensor in the terminal device. The scene identification model in the terminal device determines a current scene based on the to-be-processed data, and determines a corresponding service processing manner based on the current scene. Because the service processing manner is a service processing manner that is preset in the terminal device, operation steps of the user can be simplified, operation intelligence can be improved, and use convenience of the user can be improved. For example, the terminal device is specifically a smartphone. When the smartphone is in a screen-off state and needs to scan a picture that carries a two-dimensional code, the smartphone may automatically implement a function of a related application program or obtain information, without performing an additional operation, thereby improving use convenience of the user.

### BRIEF DESCRIPTION OF DRAWINGS

FIG. 1A is a schematic diagram of a system architecture according to an embodiment of this application,

FIG. 1B is a schematic diagram of another system architecture according to an embodiment of this application,

FIG. 2 is a schematic diagram of a use scenario in a service processing method according to an embodiment of this application,

FIG. 3 is a schematic diagram of an embodiment of a service processing method according to an embodiment of this application,

FIG. 4 is a schematic diagram of an embodiment of intelligently starting an application program according to an embodiment of this application,

FIG. 5 is a schematic diagram of an embodiment of intelligently recommending a service according to an embodiment of this application,

FIG. 6 is a schematic flowchart of an application scenario of a service processing method according to an embodiment of this application,

FIG. 7 is a schematic structural diagram of a computer system according to an embodiment of this application,

FIG. 8 is a schematic structural diagram of an AI processor according to an embodiment of this application, and

FIG. 9 is a schematic diagram of an embodiment of a service processing apparatus according to an embodiment of this application.

### DESCRIPTION OF EMBODIMENTS

This application provides a service processing method and a related apparatus. A terminal device may obtain to-be-processed data using a sensor in the terminal device. A scene identification model in the terminal device determines a current scene based on the to-be-processed data, and determines a corresponding service processing manner based on the current scene. Because the service processing manner is a service processing manner that is preset in the terminal device, operation steps of a user can be simplified, operation intelligence can be improved, and use convenience of the user can be improved.

In the specification, claims, and accompanying drawings of this application, the terms such as “first”, “second”, “third”, and “fourth” (if existent) are intended to distinguish between similar objects but do not necessarily describe a specific order or sequence. It should be understood that the data used in such a way is interchangeable in proper circumstances such that the embodiments described herein can be implemented in other orders than the order illustrated or described herein. In addition, the terms “include”, “have”, and any other variants thereof mean to cover the non-exclusive inclusion, for example, a process, method, system, product, or device that includes a list of steps or units is not necessarily limited to those expressly listed steps or units, but may include other steps or units that are not expressly listed or are inherent to such a process, method, product, or device.

Before the embodiments are described, several concepts that may occur in the embodiments are first described. It should be understood that the following concept explanations may be limited due to a specific case in the embodiments, but it does not indicate that this application is limited to the specific case. The following concept explanations may also vary with a specific case in different embodiments.

To facilitate understanding of the embodiments of this application, several concepts that may occur in this application are first described. It should be understood that the following concept explanations may be limited due to a specific case in this application, but it does not indicate that this application is limited to the specific case. The following concept explanations may also vary with a specific case in different embodiments.

1. Processor

A plurality of processors (which may also be referred to as cores or computing units) are disposed on a terminal device, and these cores constitute a processor. The cores in the embodiments of this application mainly relate to heterogeneous cores, and these cores include but are not limited to the following types.

(1) Central processing unit (CPU) The CPU is a very large scale integrated circuit, and is a computing core (core) and a control core (control unit) of a computer. A function of the CPU is mainly to interpret a computer instruction and process data in computer software.

(2) Graphics processing unit (GPU) The GPU is also referred to as a display core, a visual processor, and a display chip, is a microprocessor that specially performs image computation on a personal computer, a workstation, a game console, and some mobile terminal devices (such as a tablet computer and a smartphone).

(3) Digital signal processor (DSP) The DSP is a chip that can implement a digital signal processing technology. A Harvard structure in which a program is separated from data is used inside the DSP chip. The DSP chip has a dedicated hardware multiplier, is widely operated using a pipeline, provides a special DSP instruction, and can be used to quickly implement various digital signal processing algorithms.

(3.1) ISP The ISP is a chip that can implement image signal processing and calculation. The ISP is a type of DSP chip, and is mainly used to perform post-processing on data that is output by an image sensor. Main functions include linear correction, noise removal, defect pixel correction, interpolation, white balance, automatic exposure (AE), and the like.

(3.2) ASP The ASP is a chip that can implement audio signal processing and calculation. The ASP is a type of DSP chip, is mainly used to perform post-processing on data that is output by an audio collector. Main functions include acoustic source localization, acoustic source enhancement, echo cancellation, a noise suppression technology, and the like.

(4) AI Processor

The AI processor, also referred to as an AI processor or an AI accelerator, is a processing chip in which an AI algorithm is run, and is usually implemented using an application-specific integrated circuit (ASIC), or may be implemented using a field-programmable gate array (FPGA), or may be implemented using a GPU. This is not limited herein. The AI processor uses a systolic array structure. In the array structure, data rhythmically flows between processing units in the array in a predetermined “pipeline” manner. In a process in which the data flows, all processing units process, in parallel, the data that flows through the processing units such that the AI processor can reach a very high parallel processing speed.

The AI processor may be specifically a neural-network processing unit (NPU), a tensor processing unit (TPU), an intelligence processing unit (IPU), a GPU, or the like.

(4.1) NPU The NPU simulates human neurons and synapses at a circuit layer, directly processes a large scale of neurons and synapses using a deep learning instruction set, where one instruction is used to complete processing of a group of neurons. Compared with a von Neumann structure in which storage and computing are separated and that is used in the CPU, the NPU implements integration of storage and computing using a synaptic weight, thereby greatly improving running efficiency.

(4.2) TPU AI is intended to assign human intelligence to a machine, and machine learning is a powerful method for implementing AI. Machine learning is a discipline that studies how to enable a computer to learn automatically. The TPU is a chip that is specially used for machine learning, can be a programmable AI accelerator for a TENSORFLOW platform, and is essentially an accelerator with the systolic array structure. An instruction set in the TPU may also be run when a TENSORFLOW program is changed or an algorithm is updated. The TPU can provide low-precision computation with a high throughput, is used for forward computation of a model rather than model training, and has higher energy efficiency (terra operations per second per watt (TOPS/w)). The TPU may also be referred to as an IPU.

2. Sensor

A plurality of sensors (sensor) are disposed on the terminal device, and the terminal device obtains external information using these sensors. The sensors in the embodiments of this application include but are not limited to the following types.

(1) Infrared image sensor (IR-RGB image sensor) The infrared image sensor uses a charge-coupled device (CCD) unit or a standard complementary metal-oxide semiconductor (CMOS) unit, performs filtering using a filter through which only light of a color wavelength segment and light of a specified infrared wavelength segment are allowed to pass, and performs separation in the ISP to obtain an infrared radiation (IR) image data flow and an red green blue (RGB) image data flow. The IR image data flow is an image data flow obtained in a low-light environment, and the two image data flows obtained through separation are processed by another application.

(2) Acceleration sensor The acceleration sensor is configured to measure an acceleration change value of an object, and usually performs measurement in three directions X, Y, and Z. A value in the X direction represents horizontal direction movement of the terminal device, a value in the Y direction represents vertical direction movement of the terminal device, and a value in the Z direction represents spatial vertical direction movement of the terminal device. In an actual scenario, the acceleration sensor is configured to measure a movement speed and direction of the terminal device. For example, when a user moves by holding the terminal device, the terminal device moves up and down. In this way, the acceleration sensor can detect that an acceleration is changed in a direction back and forth, and a quantity of steps can be calculated by detecting a quantity of times the acceleration is changed back and forth.

(3) Gyroscope The gyroscope is a sensor for measuring an angular velocity of an object around a center rotation axis. A gyroscope applied to the terminal device is a micro-electro-mechanical systems (MEMS) gyroscope chip. A common MEMS gyroscope chip is a three-axis gyroscope chip, and can trace displacement changes in six directions. The three-axis gyroscope chip may obtain change values of angular accelerations of the terminal device in the x, y, and z directions, and is configured to detect a rotation direction of the terminal device.

(4) Ambient light sensor The ambient light sensor is a sensor that measures a change of external light, and measures a change of external light intensity based on a photo-electric effect. The ambient light sensor is applied to the terminal device, and is configured to adjust brightness of a display screen of the terminal device. However, because the display screen is usually a most power-consuming part of the terminal device, the ambient light sensor is configured to assist in adjusting screen brightness, thereby further extending a battery life.

(5) Proximity sensor The proximity sensor includes an infrared emitting lamp and an infrared radiation ray detector. The proximity sensor is located near a handset of the terminal device. When the terminal device is close to the ear, a system learns, using the proximity sensor, that the user is on a call, and then turns off the display screen, to prevent the user from affecting the call due to a misoperation. A working principle of the proximity sensor is as follows Invisible infrared light emitted by the infrared emitting lamp is reflected by a nearby object, and then is detected by the infrared radiation ray detector. Generally, a near infrared spectrum band is used for the emitted visible infrared light.

(6) Geomagnetic sensor The geomagnetic sensor is a measurement apparatus that may indicate, using different motion states of a measured object in a geomagnetic field because magnetic flux distribution in different directions of the geomagnetic field is different, information such as a gesture and a motion angle of the measured object by sensing a distribution change in the geomagnetic field. The geomagnetic sensor is usually used in a compass or navigation application of the terminal device, and helps the user implement accurate positioning by calculating a specific orientation of the terminal device in three-dimensional space.

3. Scene identification Scene identification is also referred to as context awareness (context awareness), is originated from study of so-called pervasive computing, and was first proposed by Schilit in 1994. Context awareness has many definitions, and briefly means enabling a computer device to be “aware” of a current scene using a sensor and a related technology of the sensor. There are also many pieces of information that can be used to perform context awareness, such as a temperature, a location, an acceleration, audio, and a video.

To make persons skilled in the art understand the solutions in this application better, the following describes the embodiments of this application with reference to the accompanying drawings in the embodiments of this application.

The service processing method provided in the embodiments of this application may be applied to a terminal device. The terminal device may be a mobile phone, a tablet computer, a laptop computer, a digital camera, a personal digital assistant (PDA), a navigation apparatus, a mobile Internet device (MID), a wearable device, a smartwatch, a smart band, or the like. Certainly, in the following embodiments, a specific form of the terminal device is not limited. A system that can be installed on the terminal device may include iOS®, Android®, Microsoft®, Linux®, or another operating system. This is not limited in the embodiments of this application.

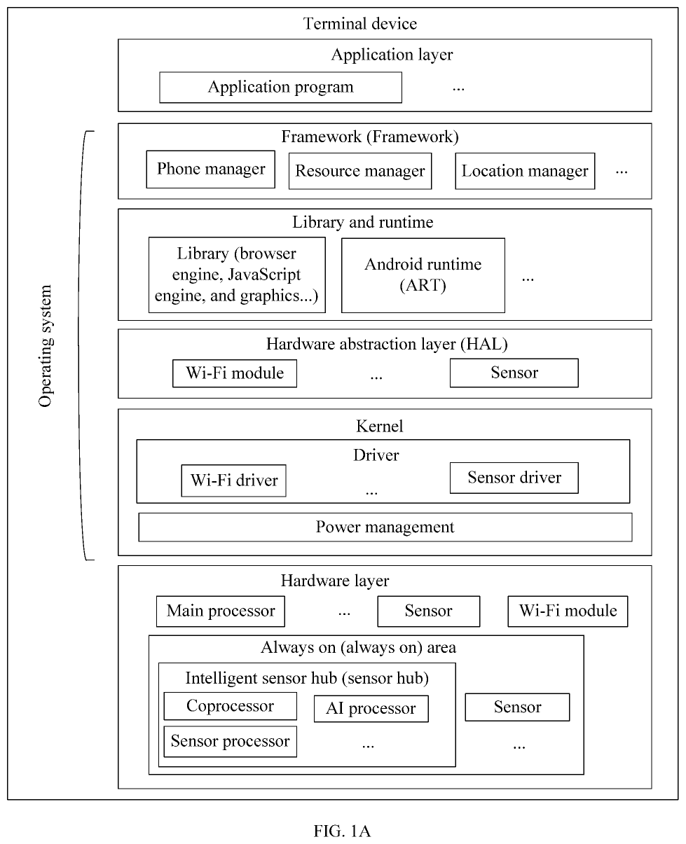

A terminal device on which an Android® operating system is installed is used as an example. FIG. 1A is a schematic diagram of a system architecture according to an embodiment of this application. The terminal device may be logically divided into a hardware layer, an operating system, and an application layer. The hardware layer includes hardware resources such as a main processor, a microcontroller unit, a modem, a WI-FI module, a sensor, and a positioning module. The application layer includes one or more application programs. For example, the application program may be any type of application program such as a social-type application, an e-commerce-type application, a browser, a multimedia-type application, and a navigation application, or may be an application program such as a scene identification model and an AI algorithm. The operating system serves as a software middleware between the hardware layer and the application layer, and is an application program that manages and controls hardware and software resources.

In addition to the hardware resources such as the main processor, the sensor, and the WI-FI module, the hardware layer further includes an always on area. Hardware in the always on area is usually started all day. The always on area further includes hardware resources such as a sensor control center (sensor hub), an AI processor, and a sensor. The sensor hub includes a coprocessor and a sensor processor. The sensor processor is configured to process data that is output by the sensor. After data generated by the AI processor and the sensor processor is further processed by the coprocessor, the coprocessor establishes an interaction relationship with the main processor. The sensor in the always on area includes an infrared image sensor, a gyroscope, an acceleration sensor, an audio collector (mic), and the like. The sensor processor includes a mini ISP and an ASP. For ease of understanding, a connection relationship between the always on area and the hardware layer is shown in FIG. 1B. FIG. 1B is a schematic diagram of another system architecture according to an embodiment of this application.

In an embodiment, the operating system includes a kernel, a hardware abstraction layer (HAL), a library and runtime (libraries and runtime), and a framework (framework). The kernel is configured to provide an underlying system component and service, for example, power management, memory management, thread management, and a hardware driver. The hardware driver includes a WI-FI driver, a sensor driver, a positioning module driver, and the like. The HAL is encapsulation of a kernel driver, provides an interface for the framework, and shields an underlying implementation detail. The HAL is run in user space, and the kernel driver is run in kernel space.

The library and runtime is also referred to as a runtime library, and provides a library file and an execution environment that are required by an executable program in a runtime. The library and runtime includes an ANDROID runtime (ART), a library, and the like. The ART is a virtual machine or a virtual machine instance that can convert bytecode of an application program into machine code. The library is a program library that provides support for the executable program in the runtime, and includes a browser engine (such as a WEBKIT), a script execution engine (such as a JAVASCRIPT engine), a graphics processing engine (PE), and the like.

The framework is configured to provide various basic common components and services for the application program in the application layer, for example, window management and location management. The framework may include a phone manager, a resource manager, a location manager, and the like.

Functions that are of the components of the operating system and that are described above may be implemented by the main processor by executing a program stored in a memory.

Persons skilled in the art may understand that the terminal may include fewer or more components than those shown in each of FIG. 1A and FIG. 1B, and the terminal device shown in each of FIG. 1A and FIG. 1B includes only components more related to a plurality of implementations disclosed in the embodiments of this application.

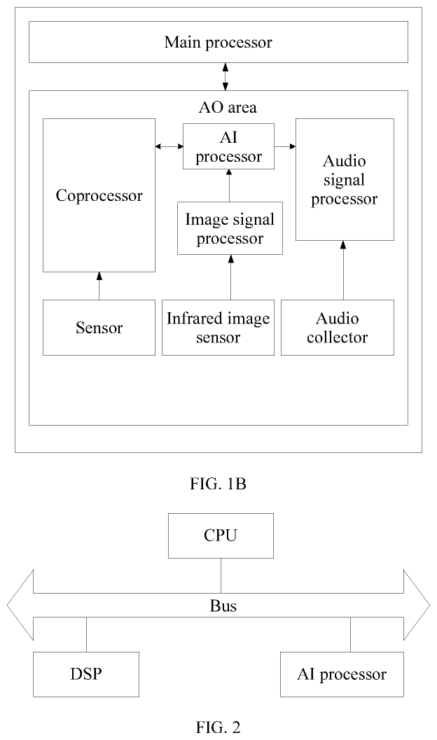

FIG. 2 is a schematic diagram of a use scenario in a service processing method according to an embodiment of this application. In the use scenario, a processor is disposed on the terminal device, and the processor includes at least two cores. The at least two cores may include a CPU, an AI processor, and the like. The AI processor includes but is not limited to a NPU, a TPU, a GPU, and the like. These chips may be referred to as cores, and are configured to perform computation on the terminal device. Different cores have different energy efficiency ratios.

The terminal device may execute different application services using a specific algorithm. The method in this embodiment of this application relates to running a scene identification model. The terminal device may determine, using the scene identification model, a target scene in which a user currently using the terminal device is located, and execute different service processing manners based on the determined target scene.

When determining the target scene in which the user currently using the terminal device is located, the terminal device determines different target scenes based on data collected by different sensors and an AI algorithm in the scene identification model.

Therefore, the embodiments of this application provide a service processing method. The following embodiments of this application mainly describes a case in which the terminal device determines, based on the data collected by different sensors and the scene identification model, a target scene in which the terminal device is located and a service processing manner corresponding to the target scene.

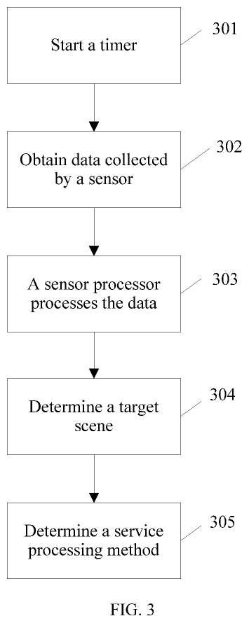

The following further describes the technical solutions in this application using an embodiment. FIG. 3 is a schematic diagram of an embodiment of a service processing method according to an embodiment of this application. The embodiment of the service processing method according to this embodiment of this application includes the following steps.

301. Start a timer.

In this embodiment, a terminal device starts a timer connected to a sensor, and the timer is used to indicate a time interval for collecting data by the sensor connected to the timer. A coprocessor in an always on area sets, based on a requirement of the scene identification model, timing time periods of timers corresponding to different sensors. For example, a timing time period of a timer corresponding to an acceleration sensor may be set to 100 milliseconds (ms). This means that acceleration data is collected at an interval of 100 ms, and the acceleration data is stored in a buffer area specified in the terminal device.

The timing time period herein may be set based on the requirement of the scene identification model, or may be set based on a plurality of requirements such as a sensor lifetime, buffer space usage, and power consumption. For example, for an infrared image sensor, the infrared image sensor may collect an infrared image at a relatively high frame frequency, but continuous collection for a long time period causes damage to the sensor and affects a lifetime. In addition, continuous collection for a long time period causes an increase in power consumption of the infrared image sensor, and reduces use duration of the terminal device. Based on the foregoing case and an actual requirement of the scene identification model, a timing time period of a timer connected to the infrared image sensor may be set to the following value, for example, in a face recognition scenario, a timing time period of image collection may be set to ⅙ second, that is, 10 frames of images are collected per second, or in another identification scenario, a timing time period of image collection may be set to 1 second, that is, one frame of image is collected per second. Alternatively, when the terminal device is in a low-power mode, the timing time period may be set to 1 second, to extend use duration of the terminal device. For some sensors that have low power consumption and whose collected data occupies relatively small storage space, a timing time period of the sensor may not be set, to collect data in real time.

It should be noted that the timer may be a chip that is connected to the sensor and that has a timing function, or may be a built-in timing function of the sensor. This is not limited herein.

302. The sensor collects data.

In this embodiment, after the timing time period of the timer expires, the sensor connected to the timer is instructed to be started and collect data. A specific sensor that needs to be used to collect data is selected by the coprocessor based on the scene identification model. For example, when the terminal device needs to determine whether the terminal device is currently in a two-dimensional code scanning scene, the terminal device collects data using the infrared image sensor. After processing and calculating the data collected by the infrared image sensor, the terminal device can complete a scene identification process. When the terminal device needs to determine whether the terminal device is currently in a conference scene, in addition to collecting data using the infrared image sensor, the terminal device further needs to collect data using an audio collector. After processing and calculating the data collected by the infrared image sensor and the data collected by the audio collector, the terminal device can complete a scene identification process.

The infrared image sensor is used as an example. After the timing time period corresponding to the infrared image sensor expires, the infrared image sensor collects image data. The image data includes an IR image and an RGB image. The IR image is a grayscale image, and may be used to display external information photographed in a low-light environment. The RGB image is a color image, and may be used to display external information photographed in a non-low-light environment. The infrared image sensor stores the collected image data into buffer space for use in a subsequent step.

There are two different application scenarios for obtaining the image data collected by the infrared image sensor. A first application scenario is that a first infrared image sensor is disposed in a housing that is in the terminal device and that is in a same plane as a home screen of the terminal device. A second application scenario is that a second infrared image sensor is disposed in a housing that is in the terminal device and that is in a same plane as a primary image sensor in the terminal device. The following separately describes the two cases.

In the first application scenario, the first infrared image sensor may collect image data projected to the home screen of the terminal device. For example, when a user performs an operation of taking a self-portrait using the terminal device, the first infrared image sensor disposed in the same plane as the home screen of the terminal device may collect face image data of the user.

In the second application scenario, the second infrared image sensor may collect image data projected to the primary image sensor in the terminal device. For example, when a user performs an operation of scanning a two-dimensional code using the primary image sensor in the terminal device, the second infrared image sensor disposed in the same plane as the primary image sensor in the terminal device may collect two-dimensional code image data.

It should be noted that, both the first infrared image sensor and the second infrared sensor may be disposed in a same terminal device. A disposition manner and a data collection manner are similar to the foregoing manners, and details are not described herein again.

The audio collector may be disposed at any location on the housing of the terminal device, and usually collects, at a sampling frequency of 16 kilohertz, audio data in an environment in which the terminal device is located.

The acceleration sensor is disposed in the always on area inside the terminal device, is connected to a sensor hub using an inter-integrated circuit (I2C) or a serial peripheral interface (SPI) SPI, and usually provides an acceleration measurement range from ±2 gravity (G) to ±16 G, where precision of collected acceleration data is less than 16 bits.

It should be noted that the data collected by the sensor may be directly sent to a sensor processor or the scene identification model for processing, or may be stored in the buffer area, where the sensor processor or the scene identification model reads the sensor data in the buffer area for processing. This is not limited herein.

303. The sensor processor processes the data.

In this embodiment, after the sensor collects the data, the sensor processor corresponding to the sensor, also referred to as a DSP corresponding to the sensor, may perform data preprocessing on the collected data to generate to-be-processed data for subsequent use in the scene identification model.

A sensor processor miniISP corresponding to the infrared image sensor is used as an example. After obtaining the image data collected by the infrared image sensor, the miniISP processes the image data. For example, when resolution (image resolution) of the image data collected by the sensor is 640 pixels×480 pixels, the miniISP may perform compression processing on the image data to generate to-be-processed image data of 320 pixels×240 pixels. The miniISP may further perform AE processing on the image data. In addition to the foregoing processing manners, the miniISP may be further configured to automatically select, based on brightness information included in the image data, an image that needs to be processed in the image data. For example, when the miniISP determines that a current image is collected in the low-light environment, because the IR image includes more image detail information in the low-light environment than the RGB image, the miniISP selects the IR image in the image data for processing.

It may be understood that, not all sensor data needs to be processed by the sensor processor, for example, the acceleration data collected by the acceleration sensor may be directly used in the scene identification model. Step 303 is an optional step.

304. Determine a target scene.

In this embodiment, the terminal device determines a corresponding target scene based on the scene identification model using the data collected by the sensor and/or the to-be-processed data obtained through processing performed by the sensor processor. The scene identification model is run on the coprocessor and an AI processor, and an AI algorithm in the scene identification model is run on the AI processor. For data collected by different sensors, a direction and a sequence in which the data flows in the scene identification model are different. For example, the to-be-processed image data generated by the miniISP through processing based on the image data and to-be-processed audio data generated by an ASP based on the audio data are first loaded to the AI algorithm that is in the scene identification model and that is run on the AI processor, and then the coprocessor determines the target scene based on a calculation result of the AI processor. The acceleration data generated by the acceleration sensor through collection is first processed by the coprocessor, and then is loaded to the AI algorithm that is in the scene identification model and that is run on the AI processor. Finally, the coprocessor determines the target scene based on a calculation result of the AI processor.

The scene identification model includes two parts. A first part is the AI algorithm. The AI algorithm includes a data set obtained by the sensor through collection and a to-be-processed data set obtained by the sensor processor through processing. A neural network model is obtained through offline training. The second part is to determine the target scene based on a calculation result of the AI algorithm, and this is completed by the coprocessor. For the image data, a convolutional neural network (CNN) is usually used. For the audio data, a deep neural network (DNN)/recurrent neural network (RNN)/long short-term memory (LSTM) network is usually used. Different DNN algorithms may be used for different data, and a specific algorithm type is not limited.

The CNN is a feedforward neural network whose artificial neuron can respond to a surrounding unit in a partial coverage range, and performs well in terms of large-scale image processing. The CNN includes one or more convolutional layers and a fully connected layer (corresponding to a classical neural network) at the top, and also includes a correlation weight and a pooling layer. This structure enables the CNN to use a two-dimensional structure of input data. A convolutional kernel of the convolutional layer in the CNN convolves images. Convolution is scanning an image using a filter of a specific parameter, and extracting a feature value of the image.

Offline training means performing model design and training in a deep learning framework such as TENSORFLOW or convolutional architecture for fast feature embedding (Caffe).

The infrared image sensor is used as an example. In the terminal device, there are a plurality of scene identification models to which infrared image data may be applied, for example, a two-dimensional code scanning scene identification model, a code scanned scene identification model, and a self-portrait scene identification model. One or more scene identification models may be applied to the terminal device. Descriptions are separately provided below.

In the two-dimensional code scanning scene identification model, a neural network model that is loaded on the AI processor and that is obtained through offline training collects 100,000 two-dimensional code images and 100,000 non-two-dimensional code images using a CNN algorithm and the sensor, and separately marks the images (with a two-dimensional code or without a two-dimensional code). After training is performed on the TENSORFLOW, the neural network model and a related parameter are obtained. Then, image data collected by the second infrared image sensor is input into the neural network model for network derivation such that a result of whether the image includes a two-dimensional code can be obtained. It should be noted that, in the two-dimensional code scanning scene identification model, during offline training, if a collected image may alternatively be another icon such as a bar code image in addition to a two-dimensional image, the two-dimensional code scanning scene identification model may be further used to identify a result of whether an image obtained by the terminal device includes a bar code and the like.

In the code scanned scene identification model, a neural network model that is loaded on the AI processor and that is obtained through offline training collects, using a CNN algorithm and the sensor, 100,000 images including a code scanning device and 100,000 images not including a code scanning device. The image including the code scanning device is image data that is collected by the sensor and that includes a scanning part in a wearable device such as a scanner, a scanning gun, a smartphone, or a smart band. The smartphone is used as an example. When the image includes a primary image sensor in the smartphone, the image is an image including a code scanning device. The neural network model separately marks the images (with a code scanning device or without a code scanning device). After training is performed on the TENSORFLOW, the neural network model and a related parameter are obtained. Then, image data collected by the first infrared image sensor is input into the neural network model for network derivation such that a result of whether the image includes a code scanning device can be obtained.

In the self-portrait scene identification model, a neural network model that is loaded on the AI processor and that is obtained through offline training collects, using a CNN algorithm and the sensor, 100,000 images including a human face and 100,000 images not including a human face. The image including a human face is an image including a part or all of a human face. The neural network model separately marks the images (with a human face or without a human face). After training is performed on the TENSORFLOW, the neural network model and a related parameter are obtained. Then, image data collected by the first infrared image sensor is input into the neural network model for network derivation such that a result of whether the image includes a human face can be obtained.

It should be noted that, in addition to determining the target scene using the image data collected by the infrared image sensor, the terminal device may further determine the target scene using data collected by a plurality of sensors, for example, the audio data collected by the audio collector and the acceleration data collected by the acceleration sensor. For example, the image data, the audio data, and the acceleration data may be used to determine whether a scene in which the terminal device is currently located is a motion scene, or a plurality of types of data are used to determine whether a scene in which the terminal device is currently located is a driving scene.

A specific used algorithm, a deep learning platform used in offline training, and a quantity of data samples collected by the sensor during offline training are not specifically limited.

305. Determine a service processing method.

In this embodiment, after the coprocessor determines the target scene, the coprocessor may determine a service processing method corresponding to the target scene, or the coprocessor may send the determined target scene to a main processor, and the main processor determines a service processing method corresponding to the target scene.

According to different scenes, there are a plurality of different corresponding service processing methods. For example, if the target scene is the driving scene, the terminal device determines, based on the driving scene, that the service processing manner is to enable a driving mode of the terminal device, and/or enable a driving mode function of an application program in the terminal device, and/or display a driving mode icon in an always on display area on a standby screen of the terminal device. The driving mode of the terminal includes a navigation function and a voice assistant, and the driving mode icon is used to enable the driving mode. Enabling the driving mode of the terminal device and enabling the driving mode function of the application program in the terminal device are steps performed by the main processor. Displaying the driving mode icon in the always on display area on the standby screen of the terminal device is a step performed by the coprocessor.

In this embodiment of this application, the service processing method is provided. The terminal device collects external multidimensional information using a plurality of sensors such as a conventional sensor, the infrared image sensor, and the audio collector, thereby improving an awareness capability of the terminal device. Because the AI processor is a dedicated chip optimized for the AI algorithm, the terminal device may greatly improve a running speed of the AI algorithm using the AI processor, and reduce power consumption of the terminal device. Because the coprocessor runs in the always on area of the terminal device, and can work without starting the main processor, the terminal device can still perform scene identification in a screen-off state.

Next, on the basis of the embodiment corresponding to FIG. 3, the following is separately described The terminal device determines, in different scenarios, a target scene in which the terminal device is located and a service processing manner corresponding to the target scene.

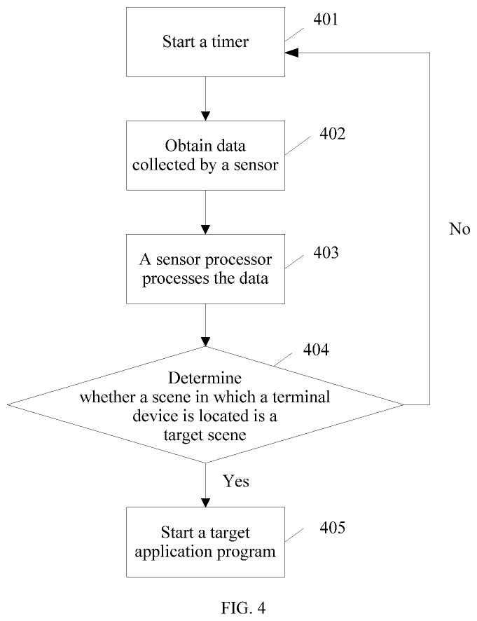

On the basis of the embodiment corresponding to FIG. 3, FIG. 4 is a schematic diagram of an embodiment of intelligently starting an application program according to an embodiment of this application. The embodiment of intelligently starting the application program according to this embodiment of this application includes the following steps.

401. Start a timer.

In this embodiment, step 401 is similar to step 301 in FIG. 3, and details are not described herein again.

402. Obtain data collected by a sensor.

In this embodiment, step 402 is similar to step 302 in FIG. 3, and details are not described herein again.

403. A sensor processor processes the data.

In this embodiment, step 403 is similar to step 303 in FIG. 3, and details are not described herein again.

404. Determine whether a scene in which a terminal device is located is a target scene.

In this embodiment, a method for determining, based on the data collected by the sensor, whether the scene in which the terminal device is located is a target scene is similar to the method in step 304 in FIG. 3, and details are not described herein again.

If the terminal device determines, based on currently obtained data, that the scene in which the terminal device is located is a target scene, the terminal device proceeds to step 405. If the terminal device determines, based on currently obtained data, that the scene in which the terminal device is located is not a target scene, the terminal device proceeds to step 401, and waits to obtain and process data collected by the sensor next time.

405. Start a target application program.

In this embodiment, after the terminal device determines, based on the data collected by the sensor, the target scene in which the terminal device is currently located, the terminal device may start a target application program corresponding to the target scene.

For example, after the terminal device determines that the current scene is a motion scene, the terminal device may start a navigation application program such as AMAP, or may start a health monitoring application program to monitor physiological data of a user of the terminal device, or may start a music play application program and play music automatically.

An infrared image sensor is used as an example that corresponds to three scene identification models to which infrared image data can be applied in step 404. Descriptions are separately provided below.

When the terminal device learns, based on a calculation result, that a current image includes a code scanning device, the terminal device may determine that the terminal device is currently located in a two-dimensional code scanning scene. In this case, the terminal device may automatically start an application program associated with a primary image sensor, start the primary image sensor, and turn on a home screen, for example, a camera application program. Alternatively, the terminal device starts an application program that has a two-dimensional code scanning function, and further enables the two-dimensional code scanning function in the application program. For example, the terminal device enables a “scan” function in a browser application program, where the “scan” function is used to scan a two-dimensional code image, and provide data, obtained through scanning, for a browser for use.

When the terminal device learns, based on a calculation result, that a current image includes a code scanning device, the terminal device may determine that the terminal device is currently located in a code scanned scene. In this case, the terminal device may start an application program having a two-dimensional code and/or a bar code, and after automatically turning on a home screen of the terminal device, display the two-dimensional code and/or the bar code of the application program on the home screen. For example, when determining that the current image includes a code scanning device, the terminal device turns on the home screen of the terminal device, and displays a payment two-dimensional code and/or bar code of a payment application program, where the payment application program may be ALIPAY or WECHAT.

When the terminal device learns, based on a calculation result, that a current image includes a human face, the terminal device may determine that the terminal device is currently located in a self-portrait scene. In this case, the terminal device may start a secondary image sensor in a same plane as a home screen, and automatically start an application program associated with the secondary image sensor, for example, enable a self-portrait function in a camera application program, turn on the home screen, and display a self-portrait function interface in the camera application program on the home screen.

In this embodiment of this application, the terminal device may automatically identify the current scene on the basis of using the infrared image sensor, and intelligently start, based on the identified scene, the application program corresponding to the target scene, thereby improving operation convenience of the user.

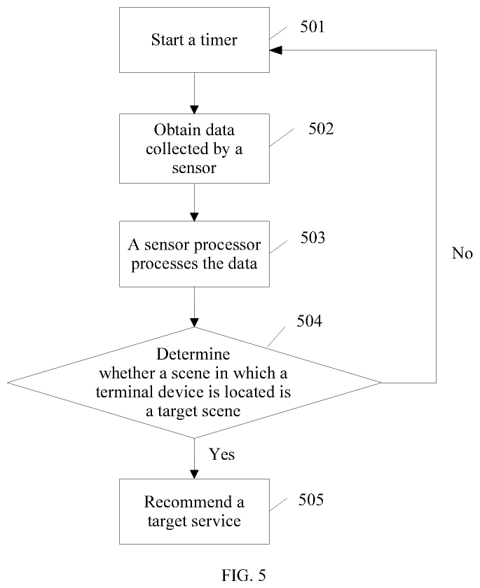

On the basis of the embodiment corresponding to FIG. 3, FIG. 5 is a schematic diagram of an embodiment of intelligently recommending a service according to an embodiment of this application. The embodiment of intelligently recommending the service according to this embodiment of this application includes the following steps.

501. Start a timer.

In this embodiment, step 501 is similar to step 301 in FIG. 3, and details are not described herein again.

502. Obtain data collected by a sensor.

In this embodiment, step 502 is similar to step 302 in FIG. 3, and details are not described herein again.

503. A sensor processor processes the data.

In this embodiment, step 503 is similar to step 303 in FIG. 3, and details are not described herein again.

504. Determine whether a scene in which a terminal device is located is a target scene.

In this embodiment, a method for determining, based on the data collected by the sensor, whether the scene in which the terminal device is located is a target scene is similar to the method in step 304 in FIG. 3, and details are not described herein again.

If the terminal device determines, based on currently obtained data, that the scene in which the terminal device is located is a target scene, the terminal device proceeds to step 505. If the terminal device determines, based on currently obtained data, that the scene in which the terminal device is located is not a target scene, the terminal device proceeds to step 501, and waits to obtain and process data collected by the sensor next time.

505. Recommend a target service.

In this embodiment, after the terminal device determines, based on the data collected by the sensor, the target scene in which the terminal device is currently located, the terminal device may recommend a target service corresponding to the target scene. The following describes a specific method for recommending the target service.

After determining the target scene in which the terminal device is located, the terminal device may recommend, to a user of the terminal device, the target service corresponding to the target scene, for example, display a function entry of the target service in an always on display (AOD) area of the terminal device, display a program entry of an application program included in the target service in the AOD area of the terminal device, automatically enable the target service, and automatically start the application program included in the target service.

For example, when the terminal device determines, based on data collected by a sensor set such as an infrared image sensor, an audio collector, and an acceleration sensor, that a current scene is a scene in which an environment in which the terminal device is located is relatively quiet, such as a conference scene or a sleep scene, the terminal device may display a silent icon in the AOD area. The terminal device may enable a silent function by receiving an operation instruction of the user for the silent icon. The silent function is to set volume of all application programs in the terminal device to 0. In addition to displaying the silent icon in the AOD area, the terminal device may further display a vibration icon in the AOD area. The terminal device may enable a vibration function by receiving an operation instruction of the user for the vibration icon. The vibration function is to set the volume of all the application programs in the terminal device to 0, and set alert sound of all the application programs in the terminal device to a vibration mode. When the terminal device fails to receive an operation instruction of a corresponding icon in the AOD area within a time period such as 15 minutes, the terminal device may automatically enable the silent function or the vibration function.

When the terminal device determines that a current scene is a motion scene, the terminal device may display a music play application program icon in the AOD area. The terminal device may start a music play application program by receiving an operation instruction of the user for the music play application program icon.

In this embodiment of this application, the terminal device may recommend a service in a low-power state such as a screen-off state, and may use a plurality of types of sensor data such as image data, audio data, and acceleration data as context awareness data to improve accuracy of context awareness using a deep learning algorithm, thereby improving operation convenience of the user.

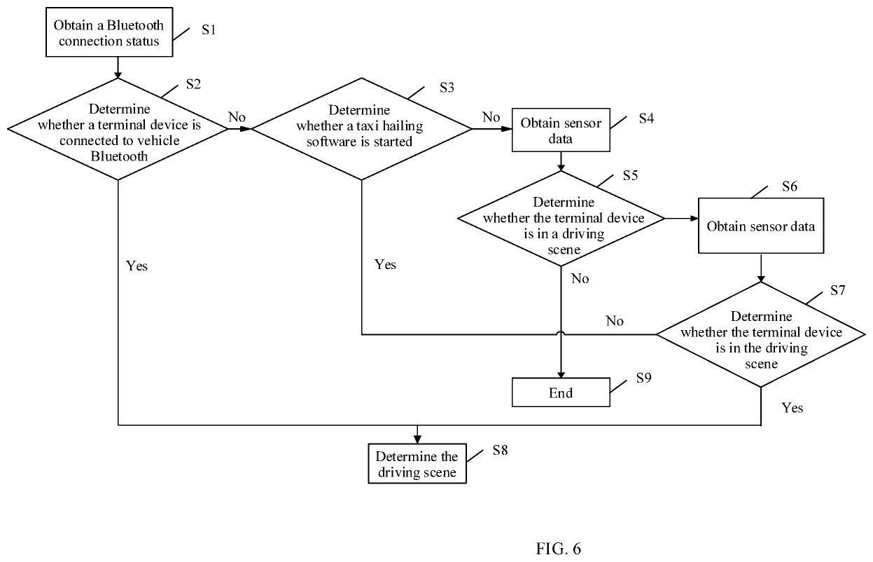

On the basis of the embodiments corresponding to FIG. 3, FIG. 4, and FIG. 5, FIG. 6 is a schematic flowchart of an application scenario of a service processing method according to an embodiment of this application. The application scenario of the service processing method according to this embodiment of this application includes the following steps.

Step S1. When a terminal device is connected to a peer device through BLUETOOTH, a user may indicate, using a mark, whether the peer device currently connected to the terminal device through BLUETOOTH is a vehicle. After the peer device is marked as a vehicle, each time the terminal device is connected to the peer device through BLUETOOTH, the terminal device may determine that the peer device currently connected to the terminal device through BLUETOOTH is a vehicle.

A coprocessor in an always on area of the terminal device obtains a BLUETOOTH connection status of the terminal device at an interval of a time period that is usually 10 seconds.

Step S2. Determine whether the terminal device is connected to vehicle BLUETOOTH.

After obtaining a current BLUETOOTH connection status, the terminal device may learn whether the terminal device currently has a peer device connected to the terminal device through BLUETOOTH. If the terminal device currently has a peer device connected to the terminal device through BLUETOOTH, the terminal device further determines whether the peer device currently connected to the terminal device through BLUETOOTH has a vehicle identifier that is set by the user. If the peer device has the vehicle identifier that is set by the user, the terminal device may determine that the terminal device is currently connected to the vehicle BLUETOOTH, and proceeds to step S8. If the terminal device is currently in a state in which BLUETOOTH is not connected or the peer device connected to the terminal device through BLUETOOTH does not have the vehicle identifier that is set by the user, the terminal device proceeds to step S3.

Step S3. The terminal device obtains data related to taxi hailing software running on the terminal device, and determines, based on the data related to the taxi hailing software, whether the taxi hailing software is currently started, that is, whether the user currently uses the taxi hailing software. If determining, based on the data related to the taxi hailing software, that the user currently uses the taxi hailing software, the terminal device proceeds to step S9. If determining, based on the data related to the taxi hailing software, that the user currently does not use the taxi hailing software, the terminal device proceeds to step S4.

Step S4. The terminal device collects acceleration data and angular velocity data using an acceleration sensor and a gyroscope, and performs data preprocessing on the collected acceleration data and the collected angular velocity data, where data preprocessing includes performing data resampling, for example, a sampling rate of original acceleration data collected by the acceleration sensor is 100 hertz (hz), and a sampling rate of acceleration data obtained after data resampling is 1 hz. A specific sampling rate of data obtained after resampling depends on a sampling rate of samples in a neural network model applied to a scene identification model, and is generally consistent with the sampling rate of the samples.

The terminal device stores the preprocessed data into a random access memory (RAM) of the terminal device. The RAM includes a Double Data Rate (DDR) synchronous dynamic RAM, a DDR2, a DDR3, a DDR4, and a DDR5 to be launched in the future.

Step S5. The scene identification model in the terminal device obtains the preprocessed acceleration data and the preprocessed angular velocity data that are stored in the RAM, and the scene identification model determines, based on the pre-processed acceleration data and the preprocessed angular velocity data, whether the terminal device is currently in a driving scene, and if yes, the terminal device proceeds to step S6, or if no, the terminal device proceeds to step S9.

Step S6. After the terminal device determines, based on the acceleration data and the angular velocity data, that the terminal device is currently in the driving scene, because reliability of a result of scene identification performed based on the acceleration data and the angular velocity data is not high, the terminal device further needs to obtain other sensor data to perform scene identification. The terminal device obtains image data collected by an infrared image sensor and audio data collected by an audio collector, and stores the collected image data and the collected audio data into the RAM of the terminal device, or after a miniISP and an ASP correspondingly process the collected image data and the collected audio data, stores the processed image data and the processed audio data into the RAM of the terminal device.

Step S7. The terminal device obtains the image data and the audio data in the RAM, loads the image data and the audio data to the scene identification model for scene identification, and determines, based on the image data and the audio data, whether the terminal device is currently in the driving scene, and if yes, the terminal device proceeds to step S8, or if no, the terminal device proceeds to step S9.

Step S8. The terminal device displays a driving scene icon in an AOD area, where the driving scene icon is a driving scene function entry of the terminal device. After the terminal device receives an operation instruction triggered by the user using the driving scene icon, the terminal device enables a driving scene mode, for example, starts a navigation application program, enlarges a size of a character displayed on the terminal device, and starts a voice operation assistant. The voice operation assistant may control an operation of the terminal device based on a voice instruction of the user, for example, perform an operation of dialing a phone number based on the voice instruction of the user.

Step S9. The terminal device ends a driving scene identification operation.

In this solution, the terminal device determines, using many sensors in the terminal device, data in various dimensions such as the acceleration data, the angular velocity data, the image data, and the audio data, and an artificial intelligence algorithm, whether a current scene is the driving scene, thereby improving accuracy of driving scene identification.

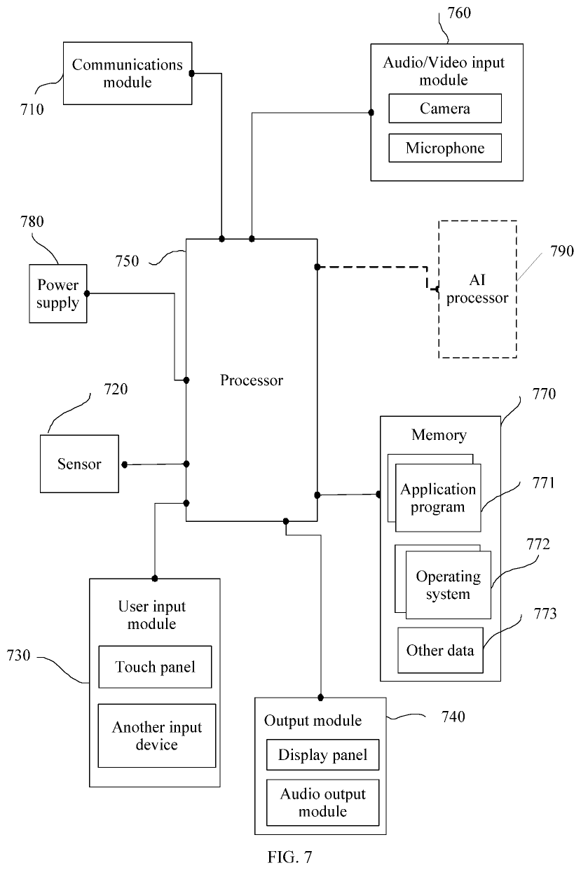

FIG. 7 is a schematic structural diagram of a computer system according to an embodiment of this application. The computer system may be a terminal device. As shown in the figure, the computer system includes a communications module 710, a sensor 720, a user input module 730, an output module 740, a processor 750, an audio/video input module 760, a memory 770, and a power supply 780. Further, the computer system provided in this embodiment may further include an AI processor 790.

The communications module 710 may include at least one module that can enable the computer system to communicate with a communications system or another computer system. For example, the communications module 710 may include one or more of a wired network interface, a broadcast receiving module, a mobile communications module, a wireless internet module, a local area communications module, and a location (or positioning) information module. Each of the plurality of modules has a plurality of implementations in other approaches, and details are not described one by one in this application.

The sensor 720 can sense a current state of the system, for example, an on/off state, a location, whether the system is in contact with a user, a direction, and acceleration/deceleration. In addition, the sensor 720 can generate a sensing signal used to control an operation of the system. The sensor 720 includes one or more of an infrared image sensor, an audio collector, an acceleration sensor, a gyroscope, an ambient light sensor, a proximity sensor, and a geomagnetic sensor.

The user input module 730 is configured to receive entered digit information, character information, or a contact touch operation/contactless gesture, and receive signal input and the like related to user settings and function control of the system. The user input module 730 includes a touch panel and/or another input device.

The output module 740 includes a display panel configured to display information entered by the user, information provided for the user, various menu interfaces of the system, or the like. Optionally, the display panel may be configured in a form of a liquid crystal display (LCD), an organic light-emitting diode (OLED), or the like. In some other embodiments, the touch panel may cover the display panel, to form a touch display screen. In addition, the output module 740 may further include an audio output module, an alarm, a tactile module, and the like.

The audio/video input module 760 is configured to input an audio signal or a video signal. The audio/video input module 760 may include a camera and a microphone.

The power supply 780 may receive external power and internal power under the control of the processor 750, and provide power required by operations of various components of the system.

The processor 750 includes one or more processors, and the processor 750 is a main processor in the computer system. For example, the processor 750 may include a CPU and a GPU. In this application, the CPU has a plurality of cores, and is a multi-core processor. The plurality of cores may be integrated into one chip, or each may be an independent chip.

The memory 770 stores a computer program, and the computer program includes an operating system program 772, an application program 771, and the like. A typical operating system includes a system used in a desktop computer or a notebook computer, such as WINDOWS of MICROSOFT or MACOS of APPLE, and also includes a system used in a mobile terminal, such as a Linux®-based Android® system developed by GOOGLE. The methods provided in the foregoing embodiments may be implemented by software, and may be considered as specific implementation of the operating system program 772.

The memory 770 may be one or more of the following types a flash memory, a memory of a hard disk type, a memory of a micro multimedia card type, a memory of a card type (for example, a secure digital (SD) memory or an extreme digital (XD) memory), a RAM, a static RAM (SRAM), a read-only memory (ROM), an electrically erasable programmable read-only memory (EEPROM), a programmable read-only memory (PROM), a replay protected memory block (RPMB) a magnetic memory, a magnetic disk, or an optical disc. In some other embodiments, the memory 770 may be a network storage device in the Internet. The system may perform an update operation, a read operation, or another operation on the memory 770 in the Internet.

The processor 750 is configured to read the computer program in the memory 770, and then perform a method defined by the computer program. For example, the processor 750 reads the operating system program 772 to run an operating system in the system and implement various functions of the operating system, or reads one or more application programs 771 to run an application in the system.

The memory 770 further stores other data 773 in addition to the computer program.

The AI processor 790 is mounted to the processor 750 as a coprocessor, and is configured to execute a task assigned by the processor 750 to the AI processor 790. In this embodiment, the AI processor 790 may be invoked by a scene identification model to implement some complex algorithms in scene identification. Specifically, an AI algorithm in the scene identification model is run on a plurality of cores of the processor 750. Then, the processor 750 invokes the AI processor 790, and a result implemented by the AI processor 790 is returned to the processor 750.

A connection relationship among the modules is only an example. A method provided in any embodiment of this application may also be applied to a terminal device in another connection manner, for example, all modules are connected using a bus.

In this embodiment of this application, the processor 750 included in the terminal device further has the following functions obtaining to-be-processed data, where the to-be-processed data is generated using data collected by a sensor, the sensor includes at least an infrared image sensor, and the to-be-processed data includes at least to-be-processed image data generated using image data collected by the infrared image sensor, determining, using a scene identification model, a target scene corresponding to the to-be-processed data, where the scene identification model is obtained through training using a sensor data set and a scene type set, and determining a service processing manner based on the target scene.

The processor 750 is specifically configured to perform the following step determining, using an AI algorithm in the scene identification model, the target scene corresponding to the to-be-processed data, where the AI algorithm includes a deep learning algorithm, and the AI algorithm is run on the AI processor 790.

The processor 750 is specifically configured to perform the following step

The sensor further includes at least one of an audio collector and a first sub-sensor, the to-be-processed data includes at least one of to-be-processed audio data and first to-be-processed sub-data, the to-be-processed audio data is generated using audio data collected by the audio collector, and the first to-be-processed sub-data is generated using first sub-sensor data collected by the first sub-sensor.

The processor 750 is specifically configured to perform the following step

The processor 750 further includes at least one of an ISP, an ASP, and the first sub-sensor processor.

The ISP is configured to when a preset running time of image collection arrives, obtain the image data using the infrared image sensor, where the image data is data collected by the infrared image sensor, and the AI processor 790 is specifically configured to obtain the to-be-processed image data using the ISP, where the to-be-processed image data is generated by the ISP based on the image data, and/or the ASP is configured to when a preset running time of audio collection arrives, obtain the audio data using the audio collector, and the AI processor 790 is specifically configured to obtain the to-be-processed audio data using the ASP, where the to-be-processed audio data is generated by the ASP based on the audio data, and/or the first sub-sensor processor is configured to when a first preset running time arrives, obtain first sub-sensor data using the first sub-sensor, where the first sub-sensor data is data collected by the first sub-sensor, and the coprocessor is specifically configured to obtain the first to-be-processed sub-data using the first sub-sensor processor, where the first to-be-processed sub-data is generated by the first sub-sensor processor based on the first sub-sensor data.

The processor 750 is specifically configured to perform the following step

The coprocessor is specifically configured to if the target scene is a two-dimensional code scanning scene, determine, based on the two-dimensional code scanning scene, that the service processing manner is to start a primary image sensor in the terminal device and/or start an application program that is in the terminal device and that supports a two-dimensional code scanning function.

The processor 750 is specifically configured to perform the following step

The coprocessor is specifically configured to if the target scene is a conference scene, determine, based on the conference scene, that the service processing manner is to enable a silent mode of the terminal device, and/or enable a silent function of an application program in the terminal device, and/or display a silent mode icon in an always on display area on a standby screen of the terminal device, where the silent mode icon is used to enable the silent mode.

The processor 750 is specifically configured to perform the following step

The coprocessor is specifically configured to if the target scene is a motion scene, determine, based on the motion scene, that the service processing manner is to enable a motion mode of the terminal device, and/or enable a motion mode function of an application program in the terminal device, and/or display a music play icon in an always on display area on a standby screen of the terminal device, where the motion mode of the terminal device includes a step counting function, and the music play icon is used to start or pause music play.

The processor 750 is specifically configured to perform the following step

The coprocessor is specifically configured to if the target scene is a driving scene, determine, based on the driving scene, that the service processing manner is to enable a driving mode of the terminal device, and/or enable a driving mode function of an application program in the terminal device, and/or display a driving mode icon in an always on display area on a standby screen of the terminal device, where the driving mode of the terminal device includes a navigation function and a voice assistant, and the driving mode icon is used to enable the driving mode.

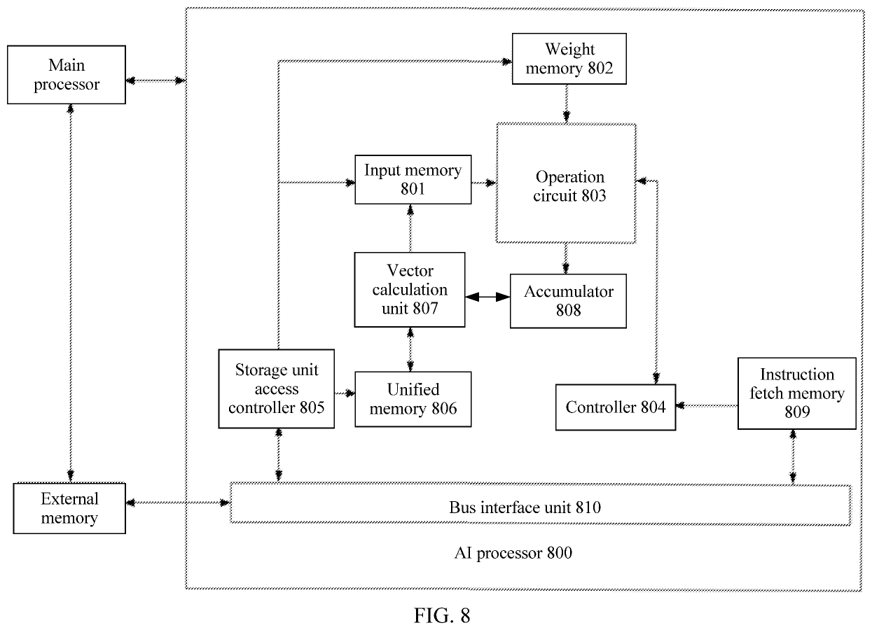

FIG. 8 is a schematic structural diagram of an AI processor according to an embodiment of this application. The AI processor 800 is connected to a main processor and an external memory. A core part of the AI processor 800 is an operation circuit 803, and a controller 804 is used to control the operation circuit 803 to extract data from a memory and perform a mathematical operation.

In some implementations, the operation circuit 803 includes a plurality of PE. In some implementations, the operation circuit 803 is a two-dimensional systolic array. Alternatively, the operation circuit 803 may be a one-dimensional systolic array or another electronic circuit that can perform a mathematical operation such as multiplication and addition. In some other implementations, the operation circuit 803 is a general-purpose matrix processor.

For example, it is assumed that there is an input matrix A, a weight matrix B, and an output matrix C. The operation circuit 803 obtains, from a weight memory 802, data corresponding to the matrix B, and buffers the data on each PE of the operation circuit 803. The operation circuit 803 obtains, from an input memory 801, data corresponding to the matrix A, performs a matrix operation on the data and the matrix B, and stores a partial result or a final result of a matrix into an accumulator 808.

A unified memory 806 is configured to store input data and output data. Weight data is directly migrated to the weight memory 802 using a storage unit access controller 805 (such as a direct memory access controller (DMAC)). The input data is also migrated to the unified memory 806 using the storage unit access controller 805.

A bus interface unit (bus interface unit, BIU) 810 is used for interaction between an advanced extensible interface (AXI) bus and each of the storage unit access controller 805 and an instruction fetch memory (instruction fetch buffer) 809.

The bus interface unit 810 is used by the instruction fetch memory 809 to fetch an instruction from the external memory, and is further used by the storage unit access controller 805 to obtain original data of the input matrix A or the weight matrix B from the external memory.

The storage unit access controller 805 is mainly configured to migrate the input data in the external memory to the unified memory 806, migrate the weight data to the weight memory 802, or migrate the input data to the input memory 801.

A vector calculation unit 807 usually includes a plurality of operation processing units. If required, further processing is performed on output of the operation circuit 803, such as vector multiplication, vector addition, an exponential operation, a logarithmic operation, and/or value comparison.

In some implementations, the vector calculation unit 807 can store a processed vector into the unified memory 806. For example, the vector calculation unit 807 may apply a nonlinear function to the output of the operation circuit 803, for example, a vector of accumulated values, to generate an activation value. In some implementations, the vector calculation unit 807 generates a normalized value, a combined value, or both of the two values. In some implementations, the processed vector can be used as activation input of the operation circuit 803.

The instruction fetch memory 809 connected to the controller 804 is configured to store an instruction used by the controller 804.

The unified memory 806, the input memory 801, the weight memory 802, and the instruction fetch memory 809 each are an on-chip memory. The external memory in the figure is independent of a hardware architecture of the AI processor.

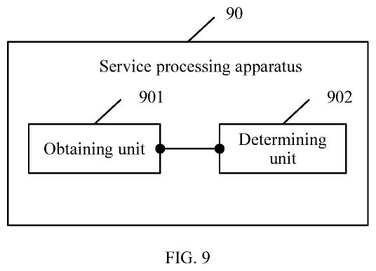

The following describes in detail a service processing apparatus corresponding to an embodiment in the embodiments of this application. FIG. 9 is a schematic diagram of an embodiment of a service processing apparatus according to an embodiment of this application. The service processing apparatus 90 in this embodiment of this application includes an obtaining unit 901 configured to obtain to-be-processed data, where the to-be-processed data is generated using data collected by a sensor, the sensor includes at least an infrared image sensor, and the to-be-processed data includes at least to-be-processed image data generated using image data collected by the infrared image sensor, and a determining unit 902 configured to determine, using a scene identification model, a target scene corresponding to the to-be-processed data, where the scene identification model is obtained through training using a sensor data set and a scene type set.

The determining unit 902 is further configured to determine a service processing manner based on the target scene.

In this embodiment, the obtaining unit 901 is configured to obtain the to-be-processed data, where the to-be-processed data is generated using the data collected by the sensor, the sensor includes at least the infrared image sensor, and the to-be-processed data includes at least the to-be-processed image data generated using the image data collected by the infrared image sensor. The determining unit 902 is configured to determine, using the scene identification model, the target scene corresponding to the to-be-processed data, where the scene identification model is obtained through training using the sensor data set and the scene type set. The determining unit 902 is further configured to determine the service processing manner based on the target scene.

In this embodiment of this application, a terminal device collects data using a sensor that is deployed in the terminal device or is connected to the terminal device, where the sensor includes at least the infrared image sensor, and the terminal device generates the to-be-processed data based on the collected data, where the to-be-processed data includes at least the to-be-processed image data generated using the image data collected by the infrared image sensor. After obtaining the to-be-processed data, the terminal device may determine, using the scene identification model, the target scene corresponding to the to-be-processed data, where the scene identification model is obtained through offline training using a data set obtained by the sensor through collection and a scene type set corresponding to different data, and offline training means performing model design and training using a deep learning framework. After determining the current target scene, the terminal device may determine a corresponding service processing manner based on the target scene. The target scene in which the terminal device is currently located may be determined using the data collected by the sensor and the scene identification model, and the corresponding service processing manner is determined based on the target scene such that the terminal device can automatically determine the service processing manner corresponding to the target scene, without performing an additional operation, thereby improving use convenience of a user.

On the basis of the embodiment corresponding to FIG. 9, in another embodiment of the service processing apparatus 90 provided in this embodiment of this application, the determining unit 902 is specifically configured to determine, using an AI algorithm in the scene identification model, the target scene corresponding to the to-be-processed data, where the AI algorithm includes a deep learning algorithm, and the AI algorithm is run on an AI processor.

In this embodiment of this application, the terminal device specifically determines, using the AI algorithm in the scene identification model, the target scene corresponding to to-be-processed data. The AI algorithm includes the deep learning algorithm, and is run on the AI processor in the terminal device. Because the AI processor has a strong parallel computing capability, and is characterized by high efficiency when the AI algorithm is run, the scene identification model determines a specific target scene using the AI algorithm, where the AI algorithm is run on the AI processor in the terminal device, thereby improving efficiency of scene identification, and further improving use convenience of the user.

On the basis of the embodiment corresponding to FIG. 9, in another embodiment of the service processing apparatus 90 provided in this embodiment of this application, the sensor further includes at least one of an audio collector and a first sub-sensor, the to-be-processed data includes at least one of to-be-processed audio data and first to-be-processed sub-data, the to-be-processed audio data is generated using audio data collected by the audio collector, and the first to-be-processed sub-data is generated using first sub-sensor data collected by the first sub-sensor.

In this embodiment of this application, in addition to the infrared image sensor, the sensor deployed in the terminal device further includes one of the audio collector and the first sub-sensor. The first sub-sensor may be one or more of the following sensors an acceleration sensor, a gyroscope, an ambient light sensor, a proximity sensor, and a geomagnetic sensor. The audio collector collects the audio data, and the audio data is processed by the terminal device to generate the to-be-processed audio data. The first sub-sensor collects the first sub-sensor data, and the first sub-sensor data is processed by the terminal device to generate to-be-processed first sub-sensor data. The terminal device collects data in a plurality of dimensions using a plurality of sensors, thereby improving accuracy of scene identification.

On the basis of the embodiment corresponding to FIG. 9, in another embodiment of the service processing apparatus 90 provided in this embodiment of this application, the obtaining unit 901 is specifically configured to when a preset running time of image collection arrives, obtain, by the obtaining unit 901, the image data using the infrared image sensor, where the image data is data collected by the infrared image sensor, and the obtaining unit 901 is specifically configured to obtain the to-be-processed image data using an ISP, where the to-be-processed image data is generated by the ISP based on the image data, and/or the obtaining unit 901 is specifically configured to when a preset running time of audio collection arrives, obtain, by the obtaining unit 901, the audio data using the audio collector, and the obtaining unit 901 is specifically configured to obtain the to-be-processed audio data using an ASP, where the to-be-processed audio data is generated by the ASP based on the audio data, and/or the obtaining unit 901 is specifically configured to when a first preset running time arrives, obtain, by the obtaining unit 901, the first sub-sensor data using the first sub-sensor, where the first sub-sensor data is data collected by the first sub-sensor, and the obtaining unit 901 is specifically configured to obtain the first to-be-processed sub-data using a first sub-sensor processor, where the first to-be-processed sub-data is generated by the first sub-sensor processor based on the first sub-sensor data.

In this embodiment of this application, one or more of the infrared image sensor, the audio collector, and the first sub-sensor may separately collect data, corresponding to the sensor, after their respective preset running times arrive. After original sensor data is collected, the terminal device processes the original sensor data using a processor corresponding to the sensor, to generate to-be-processed sensor data. The preset running time is set, and the sensor is started to collect data through timing such that the collected original data can be processed by the processor corresponding to the sensor, thereby reducing buffer space occupied by the scene identification model, reducing power consumption of the scene identification model, and improving use duration of the terminal device in a standby mode.

On the basis of the embodiment corresponding to FIG. 9, in another embodiment of the service processing apparatus 90 provided in this embodiment of this application, the determining unit 902 is specifically configured to if the determining unit 902 determines that the target scene is a two-dimensional code scanning scene, determine, by the determining unit 902 based on the two-dimensional code scanning scene, that the service processing manner is to start a primary image sensor in the terminal device and/or start an application program that is in the terminal device and that supports a two-dimensional code scanning function.

In this embodiment of this application, when determining, based on the data collected by the one or more sensors in the terminal device, that the target scene corresponding to the data collected by the sensors is the two-dimensional code scanning scene, the terminal device determines a service processing manner corresponding to the two-dimensional code scanning scene. The service processing manner includes starting the primary image sensor in the terminal device. The terminal device may scan a two-dimensional code using the primary image sensor. Alternatively, the terminal device may start the application program that supports the two-dimensional code scanning function, for example, start an application program WECHAT and enable a two-dimensional code scanning function in WECHAT. The primary image sensor and the application program that supports the two-dimensional code scanning function may be both started, or the primary image sensor or the application program that supports the two-dimensional code scanning function may be started based on a preset instruction or an instruction received from the user. This is not limited herein. In addition to scanning the two-dimensional code, the primary image sensor may be further used to scan another icon such as a bar code. This is not limited herein. After determining, using the scene identification model and the data collected by the multidimensional sensor, that the target scene is the two-dimensional code scanning scene, the terminal device may automatically execute a related service processing manner, thereby improving intelligence of the terminal device and operation convenience of the user.

On the basis of the embodiment corresponding to FIG. 9, in another embodiment of the service processing apparatus 90 provided in this embodiment of this application, the determining unit 902 is specifically configured to if the determining unit 902 determines that the target scene is a conference scene, determine, by the determining unit 902 based on the conference scene, that the service processing manner is to enable a silent mode of the terminal device, and/or enable a silent function of an application program in the terminal device, and/or display a silent mode icon in an always on display area on a standby screen of the terminal device, where the silent mode icon is used to enable the silent mode.

In this embodiment of this application, when determining, based on the data collected by the one or more sensors in the terminal device, that the target scene corresponding to the data collected by the sensors is the conference scene, the terminal device determines a service processing manner corresponding to the conference scene. The service processing manner includes enabling the silent mode of the terminal device. When the terminal device is in the silent mode, all application programs running on the terminal device are in a silent state. Alternatively, the terminal device may enable the silent function of the application program running on the terminal device, for example, enable a silent function of an application program WECHAT. In this case, alert sound of WECHAT is switched to the silent mode. Alternatively, the terminal device may display the silent mode icon in the always on display area on the standby screen of the terminal device. The terminal device may receive a silent operation instruction of the user using the silent mode icon, and the terminal device enables the silent mode in response to the silent operation instruction. After determining, using the scene identification model and the data collected by the multidimensional sensor, that the target scene is the conference scene, the terminal device may automatically execute a related service processing manner, thereby improving intelligence of the terminal device and operation convenience of the user.

On the basis of the embodiment corresponding to FIG. 9, in another embodiment of the service processing apparatus 90 provided in this embodiment of this application, the determining unit 902 is specifically configured to if the determining unit 902 determines that the target scene is a motion scene, determine, by the determining unit 902 based on the motion scene, that the service processing manner is to enable a motion mode of the terminal device, and/or enable a motion mode function of an application program in the terminal device, and/or display a music play icon in an always on display area on a standby screen of the terminal device, where the motion mode of the terminal device includes a step counting function, and the music play icon is used to start or pause music play.

In this embodiment of this application, when determining, based on the data collected by the one or more sensors in the terminal device, that the target scene corresponding to the data collected by the sensors is the motion scene, the terminal device determines a service processing manner corresponding to the motion scene. The service processing manner includes enabling the motion mode of the terminal device. When the terminal device is in the motion mode, the terminal device starts a step counting application program and a physiological data monitoring application program, and records a quantity of steps and related physiological data of the user using a related sensor in the terminal device. Alternatively, the terminal device may enable the motion mode function of the application program in the terminal device, for example, enable a motion function of an application program NETEASE Cloud Music. In this case, a play mode of NETEASE Cloud Music is the motion mode. Alternatively, the terminal device may display the music play icon in the always on display area on the standby screen of the terminal device. The terminal device may receive a music play instruction of the user using the music play icon, and the terminal device starts or pauses music play in response to the music play instruction. After determining, using the scene identification model and the data collected by the multidimensional sensor, that the target scene is the motion scene, the terminal device may automatically execute a related service processing manner, thereby improving intelligence of the terminal device and operation convenience of the user.

On the basis of the embodiment corresponding to FIG. 9, in another embodiment of the service processing apparatus 90 provided in this embodiment of this application, the determining unit 902 is specifically configured to if the determining unit 902 determines that the target scene is a driving scene, determine, by the determining unit 902 based on the driving scene, that the service processing manner is to enable a driving mode of the terminal device, and/or enable a driving mode function of an application program in the terminal device, and/or display a driving mode icon in an always on display area on a standby screen of the terminal device, where the driving mode of the terminal device includes a navigation function and a voice assistant, and the driving mode icon is used to enable the driving mode.

In this embodiment of this application, when determining, based on the data collected by the one or more sensors in the terminal device, that the target scene corresponding to the data collected by the sensors is the driving scene, the terminal device determines a service processing manner corresponding to the driving scene. The service processing manner includes enabling the driving mode of the terminal device. When the terminal device is in the driving mode, the terminal device starts the voice assistant, where the terminal device may perform a related operation based on a voice instruction entered by the user, and the terminal device may further enable the navigation function. Alternatively, the terminal device may enable the driving mode function of the application program in the terminal device, for example, enable a driving mode function of an application program AMAP. In this case, a navigation mode of NETEASE Cloud Music is the driving mode. Alternatively, the terminal device may display the driving mode icon in the always on display area on the standby screen of the terminal device. The terminal device may receive a driving mode instruction of the user using the driving mode icon, and the terminal device enables the driving mode in response to the driving mode instruction. After determining, using the scene identification model and the data collected by the multidimensional sensor, that the target scene is the driving scene, the terminal device may automatically execute a related service processing manner, thereby improving intelligence of the terminal device and operation convenience of the user.

It may be clearly understood by persons skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, function units in the embodiments of this application may be integrated into one processing unit, or each of the units may exist alone physically, or two or more units may be integrated into one unit. The integrated unit may be implemented in a form of hardware, or may be implemented in a form of a software function unit.

When the integrated unit is implemented in the form of a software function unit and sold or used as an independent product, the integrated unit may be stored in a computer readable storage medium. Based on such an understanding, the technical solutions may be implemented in a form of a software product. The computer software product is stored in a storage medium, and includes several instructions for instructing a computer device (which may be a personal computer, a server, a network device, or the like) to perform all or some of the steps of the methods in the embodiments of this application. The foregoing storage medium includes any medium that can store program code, such as a Universal Serial Bus (USB) flash drive, a removable hard disk, a ROM, a RAM, a magnetic disk, or an optical disc.

The foregoing embodiments are merely intended for describing the technical solutions in this application, and are not intended to limit this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of this application.

What is claimed is:

1. A service processing method, implemented by a terminal device, wherein the service processing method comprises:
obtaining to-be-processed data, wherein the to-be-processed data is based on data from a sensor, wherein the sensor comprises an image sensor, and wherein the to-be-processed data comprises to-be-processed image data that is based on image data of the image sensor;
determining a target scene of the to-be-processed data using a scene identification model, wherein the scene identification model is based on training using a sensor data set and a scene type set; and
determining a service processing manner based on the target scene.

2. The service processing method of claim 1, further comprising determining the target scene using an artificial intelligence (AI) algorithm in the scene identification model, wherein the AI algorithm comprises a deep learning algorithm, and wherein the AI algorithm is run on an AI processor.

3. The service processing method of claim 2, wherein the sensor further comprises at least one of an audio collector or a first sub-sensor, wherein the to-be-processed data comprises at least one of to-be-processed audio data or first to-be-processed sub-data, wherein the to-be-processed audio data is based on audio data from the audio collector, and wherein the first to-be-processed sub-data is based on first sub-sensor data of the first sub-sensor.

4. The service processing method of claim 3, further comprising perform at least one of:
(1) obtaining the image data using the image sensor when a first preset running time of image collection arrives, wherein the image data is based on data from the image sensor; and
obtaining the to-be-processed image data using an image signal processor when the first preset running time of image collection arrives, wherein the to-be-processed image data is from the image signal processor based on the image data; or
(2) obtaining the audio data using the audio collector when a second preset running time of audio collection arrives; and
obtaining the to-be-processed audio data using an audio signal processor when the second preset running time of audio collection arrives, wherein the to-be-processed audio data is from the audio signal processor based on the audio data; or
(3) obtaining the first sub-sensor data using the first sub-sensor when a third preset running time arrives, wherein the first sub-sensor data is based on data from the first sub-sensor; and
obtaining the first to-be-processed sub-data using a first sub-sensor processor, wherein the first to-be-processed sub-data is from the first sub-sensor processor based on the first sub-sensor data.

5. The service processing method of claim 1, further comprising determining, based on a two-dimensional code scanning scene, that the service processing manner is to start a primary image sensor in the terminal device or start an application program that is in the terminal device and that supports a two-dimensional code scanning function when the target scene is the two-dimensional code scanning scene.

6. The service processing method of claim 1, further comprising determining, based on a conference scene, that the service processing manner is to enable a silent mode of the terminal device or enable a silent function of an application program in the terminal device or display a silent mode icon in an always on display area on a standby screen of the terminal device when the target scene is the conference scene, wherein the silent mode icon enables the silent mode.

7. The service processing method of claim 1, further comprising determining, based on a motion scene, that the service processing manner is to enable a motion mode of the terminal device or enable a motion mode function of an application program in the terminal device or display a music play icon in an always on display area on a standby screen of the terminal device when the target scene is the motion scene, wherein the motion mode of the terminal device comprises a step counting function, and wherein the music play icon starts or pauses music play.

8. The service processing method of claim 1, further comprising determining, based on a driving scene, that the service processing manner is to enable a driving mode of the terminal device or enable a driving mode function of an application program in the terminal device or display a driving mode icon in an always on display area on a standby screen of the terminal device when the target scene is the driving scene, wherein the driving mode of the terminal device comprises a navigation function and a voice assistant, and wherein the driving mode icon enables the driving mode.

9. A terminal device, comprising:
a sensor comprising an image sensor; and
a processor coupled to the sensor and configured to:
obtain to-be-processed data, wherein the to-be-processed data is based on data from the sensor, and wherein the to-be-processed data comprises at least to-be-processed image data that is based on image data from the image sensor;
determine a target scene of the to-be-processed data by using a scene identification model, wherein the scene identification model is based on training using a sensor data set and a scene type set; and
determine a service processing manner based on the target scene.

10. The terminal device of claim 9, wherein the processor further comprises a coprocessor and an artificial intelligence (AI) processor, wherein the processor is further configured to determine the target scene using an AI algorithm in the scene identification model, wherein the AI algorithm comprises a deep learning algorithm, and wherein the AI algorithm is run on the AI processor.

11. The terminal device of claim 10, wherein the sensor further comprises at least one of an audio collector or a first sub-sensor.

12. The terminal device of claim 11, wherein the processor further comprises at least one of an image signal processor, an audio signal processor, or a first sub-sensor processor,
wherein the image signal processor is configured to obtain the image data using the image sensor when a first preset running time of image collection arrives, wherein the image data is based on data from the image sensor and the AI processor is further configured to obtain the to-be-processed image data using the image signal processor, wherein the to-be-processed image data is from the image signal processor based on the image data; or
wherein the audio signal processor is configured to obtain audio data using the audio collector when a second preset running time of audio collection arrives and the AI processor is further configured to obtain to-be-processed audio data using the audio signal processor, wherein the to-be-processed audio data is from the audio signal processor based on the audio data; or
wherein the first sub-sensor processor is configured to obtain first sub-sensor data by using the first sub-sensor when a third preset running time arrives, wherein the first sub-sensor data is based on data from the first sub-sensor and the coprocessor is further configured to obtain first to-be-processed sub-data using the first sub-sensor processor, wherein the first to-be-processed sub-data is from the first sub-sensor processor based on the first sub-sensor data.

13. The terminal device of claim 9, wherein the terminal device further comprises a coprocessor configured to determine, based on a two-dimensional code scanning scene, that the service processing manner is to start a primary image sensor in the terminal device or start an application program that is in the terminal device and that supports a two-dimensional code scanning function when the target scene is the two-dimensional code scanning scene.

14. The terminal device of claim 9, wherein the terminal device further comprises a coprocessor configured to determine, based on a conference scene, that the service processing manner is to enable a silent mode of the terminal device, or enable a silent function of an application program in the terminal device, or display a silent mode icon in an always on display area on a standby screen of the terminal device when the target scene is the conference scene, wherein the silent mode icon enables the silent mode.

15. The terminal device of claim 9, wherein the terminal device further comprises a coprocessor configured to determine, based on a motion scene, that the service processing manner is to enable a motion mode of the terminal device, or enable a motion mode function of an application program in the terminal device, or display a music play icon in an always on display area on a standby screen of the terminal device when the target scene is the motion scene, wherein the motion mode of the terminal device comprises a step counting function, and wherein the music play icon starts or pauses music play.

16. The terminal device of claim 9, wherein the terminal device further comprises a coprocessor configured to determine, based on a driving scene, that the service processing manner is to enable a driving mode of the terminal device, or enable a driving mode function of an application program in the terminal device, or display a driving mode icon in an always on display area on a standby screen of the terminal device when the target scene is the driving scene, wherein the driving mode of the terminal device comprises a navigation function and a voice assistant, and wherein the driving mode icon enables the driving mode.

17. A computer program product comprising computer-executable instructions for storage on a non-transitory computer-readable medium that, when executed by a processor, cause a computer to:
obtaining to-be-processed data, wherein the to-be-processed data is based on data from a sensor, wherein the sensor comprises an image sensor, and wherein the to-be-processed data comprises to-be-processed image data that is based on image data from the image sensor;
determining a target scene of the to-be-processed data using a scene identification model, wherein the scene identification model is based on training using a sensor data set and a scene type set; and
determining a service processing manner based on the target scene.

18. The computer program product of claim 17, wherein the computer is further configured to determine the target scene using an artificial intelligence (AI) algorithm in the scene identification model, wherein the AI algorithm comprises a deep learning algorithm, and wherein the AI algorithm is run on an AI processor of the computer.

19. The computer program product of claim 17, wherein the sensor further comprises at least one of an audio collector or a first sub-sensor, wherein the to-be-processed data comprises at least one of to-be-processed audio data or first to-be-processed sub-data, wherein the to-be-processed audio data is based on audio data of the audio collector, and wherein the first to-be-processed sub-data is based on first sub-sensor data of the first sub-sensor.

20. The computer program product of claim 17, wherein the instructions further cause the computer to determine, based on a two-dimensional code scanning scene, that the service processing manner is to start a primary image sensor in the computer or start an application program that is in the computer and that supports a two-dimensional code scanning function when the target scene is the two-dimensional code scanning scene.
